(19) United States
(12) Patent Application Publication
(10) Pub. No.: US 2009/0116966 A1
(43) Pub. Date: May 7, 2009

(54) WIND TURBINE BLADES AND METHODS FOR FORMING SAME

(76) Inventors: Nicholas Keane Althoff, Ware Shoals, SC (US); Brandon Shane Gerber, Ware Shoals, SC (US); Uli Ramm, Niedersachsen (DE)

Correspondence Address: PATRICK W. RASCHE (22402);ARMSTRONG TEASDALE LLP, ONE METROPOLITAN SQUARE, SUITE 2600, ST. LOUIS, MO, 63102-2740, US

(21) Appl. No.: 11/935,929

(22) Filed: Nov. 6, 2007

(51) Int. Cl. F01D 5/14; F03D 11/00

(52) U.S. Cl. 416/230; 416/241 A

(57) ABSTRACT

A method of forming a wind turbine blade includes forming a fiber-reinforced resin body. The fiber-reinforced resin body includes a fiber-resin matrix formed with, at least partially, at least one of at least one resin/additive mixture produced by mixing at least one first opaque additive within a first quantity of resin and a first layer of fibers having a plurality of pigmented fibers. The pigmented fibers are formed by at least one of impregnating at least a portion of the first layer of fibers with at least one second opaque additive and forming at least one layer of opaque coating over at least a portion of the first layer of fibers. The opaque coating has a third opaque additive.

### BACKGROUND OF THE INVENTION

This invention relates generally to rotary machines and more particularly, to wind turbine blades and methods for forming same.

Generally, a wind turbine includes a rotor having multiple blades. The rotor is mounted on a housing, or nacelle, that is positioned on top of a truss or tubular tower. Utility grade wind turbines (i.e., wind turbines designed to provide electrical power to a utility grid) can have large rotors, e.g., 30 meters (m) (98 feet (ft)) or more in diameter. Blades, attached to rotatable hubs on these rotors, transform mechanical wind energy into a mechanical rotational torque that drives one or more generators. The generators are generally, but not always, rotationally coupled to the rotor through a gearbox. The gearbox steps up the inherently low rotational speed of the turbine rotor for the generator to efficiently convert the rotational mechanical energy to electrical energy, which is fed into a utility grid. Gearless direct drive turbines also exist.

Some known blades are at least partially fabricated of a laminated (i.e., layered) fiber/resin composite material. In general, reinforcing fibers are deposited into a resin within a range of predetermined orientations. The fiber orientations are often determined by a range of expected stress factors that a blade may experience during an expected blade lifetime. These blades typically have a protective layer formed over the outermost surface. The protective layer is formed using either a gel coat or a paint. The methods of forming such protective layers are labor-intensive, time consuming and expensive. Moreover, such layer formation increases the weight of the blade.

### BRIEF DESCRIPTION OF THE INVENTION

In one aspect, a method of forming a wind turbine blade is provided. The method includes forming a fiber-reinforced resin body. The fiber-reinforced resin body includes a fiber-resin matrix formed with, at least partially, at least one of at least one resin/additive mixture produced by mixing at least one first opaque additive within a first quantity of resin and a first layer of fibers having a plurality of pigmented fibers. The pigmented fibers are formed by at least one of impregnating at least a portion of the first layer of fibers with at least one second opaque additive and forming at least one layer of opaque coating over at least a portion of the first layer of fibers. The opaque coating has a third opaque additive.

In another aspect, a wind turbine blade is provided. The wind turbine blade includes a fiber-reinforced resin body at least partially formed from at least one of at least one resin/additive mixture and a first layer of fibers having a plurality of pigmented fibers. The at least one resin/additive mixture includes at least one first opaque additive mixed within a quantity of resin The pigmented fibers include at least one of at least a portion of the first layer of fibers impregnated with at least one second opaque additive and at least one layer of opaque coating over at least a portion of the first layer of fibers. The opaque coating includes at least one third opaque additive.

In a further aspect, a wind turbine system is provided. The system includes a rotatable hub. The system also includes at least one wind turbine blade coupled to the rotatable hub. The wind turbine blade includes a fiber-reinforced resin body at least partially formed from at least one of at least one resin/additive mixture and a first layer of fibers having a plurality of pigmented fibers. The at least one resin/additive mixture includes at least one first opaque additive mixed within a quantity of resin The pigmented fibers include at least one of at least a portion of the first layer of fibers impregnated with at least one second opaque additive and at least one layer of opaque coating over at least a portion of the first layer of fibers. The opaque coating includes at least one third opaque additive.

### BRIEF DESCRIPTION OF THE DRAWINGS

FIG. 1 is an orthographic view of an exemplary wind turbine system;

FIG. 2 is an orthographic view of an exemplary wind turbine blade that may be used with the wind turbine system in FIG. 1;

FIG. 3 is an expanded orthographic view of a portion of the wind turbine blade shown in FIG. 2 and taken along area 3; and

FIG. 4 is an overhead view of the exemplary portion of the wind turbine blade shown in FIG. 3.

### DETAILED DESCRIPTION OF THE INVENTION

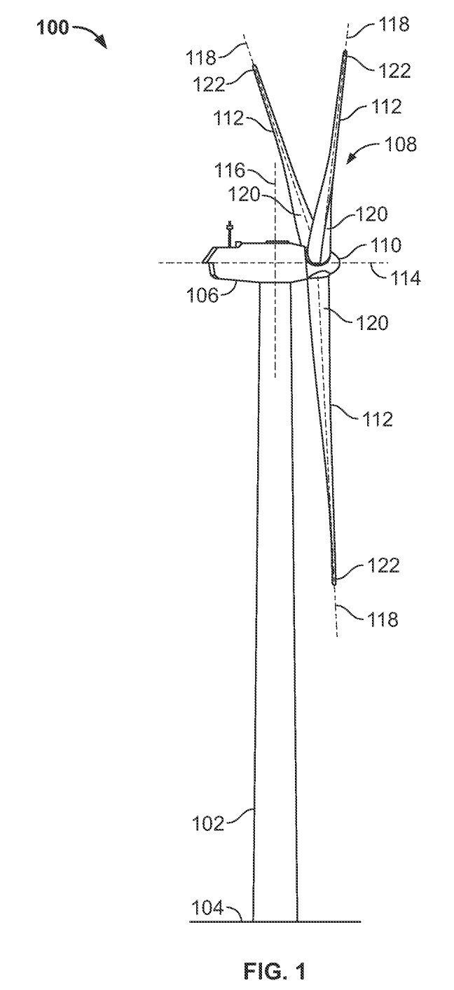

FIG. 1 is an orthographic view of an exemplary wind turbine system 100. In the exemplary embodiment, system 100 is a horizontal axis wind turbine. Alternatively, system 100 may be a vertical axis wind turbine. Wind turbine 100 has a tower 102 extending from a supporting surface 104, a nacelle 106 mounted on tower 102, and a rotor 108 coupled to nacelle 106. Rotor 108 has a rotatable hub 110 and a plurality of rotor blades 112 coupled to hub 110. In the exemplary embodiment, rotor 108 has three rotor blades 112. In an alternative embodiment, rotor 108 may have more or less than three blades 112. Rotor 108, hub 110, and blades 112 are oriented and configured to rotate about a rotation axis 114. In the exemplary embodiment, tower 102 is fabricated from tubular steel and has a cavity (not shown) extending between supporting surface 104 and nacelle 106. In an alternative embodiment, tower 102 is a lattice tower.

Various components of wind turbine 100, in the exemplary embodiment, are housed in nacelle 106 atop tower 102 of wind turbine 100. For example, rotor 108 is coupled to an electric generator (not shown in FIG. 1) that is positioned within nacelle 106. Rotation of rotor 108 about axis 114 facilitates production of electric power generation by the generator. Also positioned in nacelle 106 is a yaw adjustment mechanism (not shown) that may be used to rotate nacelle 106 and rotor 108 on a yaw axis 116 to control the perspective of blades 112 with respect to the direction of the wind. The height of tower 102 is selected based upon factors and conditions known in the art.

In the exemplary embodiment, blades 112 may have any length that facilitates operation of wind turbine 100 as described herein. Blades 112 are positioned about rotor hub 110 to facilitate rotating rotor 108 to transfer kinetic energy from wind into usable mechanical energy, and subsequently, electrical energy. As wind strikes blades 112, rotor 108 is rotated about rotation axis 114. As blades are rotated and subjected to centrifugal forces, blades are subjected to various bending moments and other operational stresses. As such, blades may deflect and/or rotate from a neutral, or non-deflected, position to a deflected position and an associated stress may be induced in blades.

In the exemplary embodiment, blades are rotated about a pitch axis 118. Specifically, a pitch angle (not shown) of blades, i.e., the angle that determines blades perspective with respect to the direction of wind, may be changed by a pitch adjustment mechanism (not shown) to facilitate increasing or decreasing a speed of rotor 108 by adjusting the surface area of blades exposed to wind force vectors. In the exemplary embodiment, the pitches of blades are controlled individually. Alternatively, the pitch of blades is controlled as a group.

Each of blades 112 include a blade root portion 120 that facilitates mating blades 112 to hub 110. Blades 112 each also include a blade tip portion 122 positioned at a longitudinally outermost portion of blades 112.

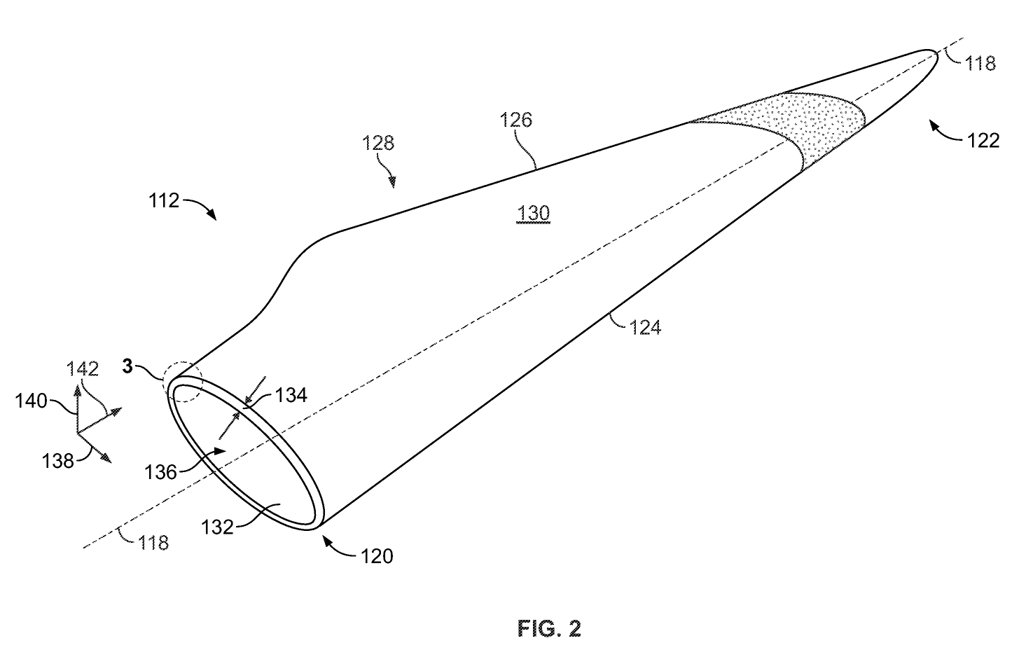

FIG. 2 is an orthographic view of one exemplary wind turbine blade 112 that may be used with wind turbine system 100 (shown in FIG. 1). Pitch axis 118, blade root portion 120 and blade tip portion 122 are illustrated for perspective. Hub attachment apparatus (not shown) is typically coupled to root portion 120. Blade 112 includes a leading edge 124 and a trailing edge 126. Blade 112 also includes a fiber-reinforced resin body, or outer skin 128, that extends substantially over all of blade 112. Skin 128 includes an outer surface 130, an inner surface 132, and has a thickness 134. Typically, thickness 134 is a function of a predetermined loading within each of a plurality of specific portions of blade 112, wherein such loading is determined as is known in the art. In the exemplary embodiment, thickness 134 varies along blade 112 between root portion 120 and tip portion 122. Specifically, thickness 134 at root portion 120 is greater than thickness 134 at tip portion 122 to facilitate a larger expected load transfer within root portion 120 as loads at blade 112 are channeled into hub 110 via portion 120. More specifically, a typical range of values for thickness 134 at tip portion 122 is approximately 0.05 millimeters (mm) (0.0020 inches (in.)) to 3 mm (0.118 in.). Also, specifically, a typical range of values for thickness 134 at root portion 120 is 50 mm to 200 mm (1.97 in. to 7.87 in.). Further, specifically, thickness 134 decreases at predetermined values as a function of distance towards tip portion 122 from root portion 120. Alternatively, any thickness 134 that facilitates operation of blade 112 may be used at root portion 120, tip portion 122, and all regions therebetween. Further alternatively, any sizing of thickness 134 about blade 112 is used including, but not limited to, varying thickness 134 as a function of distance between leading edge 124 and trailing edge 126, and using a substantially constant thickness 134 about blade 112 in its entirety.

Inner surface 132 at least partially defines a blade cavity 136. In the exemplary embodiment, cavity 136 includes a plurality of blade structural support members (not shown). Alternatively, cavity 136 includes features such as, but not limited to, heating channels, monitoring devices, and access passages (neither shown). Area 3 represents a portion of skin 128 and is discussed in more detail below. An x-axis 138 represents a horizontal reference. Also, a y-axis 140 represents a vertical reference. Moreover, a z-axis 142 represents a longitudinal length reference.

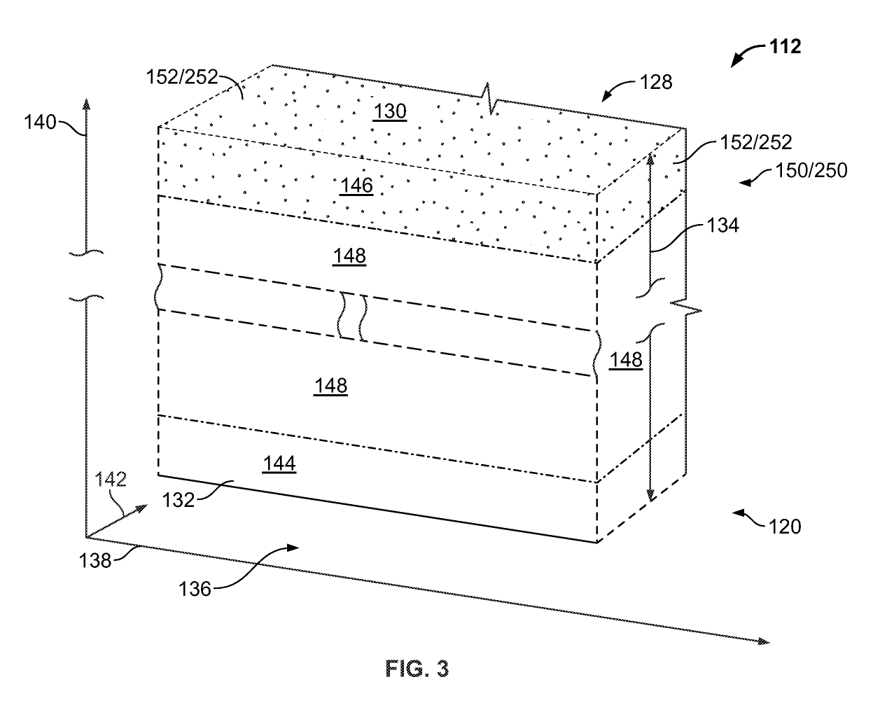

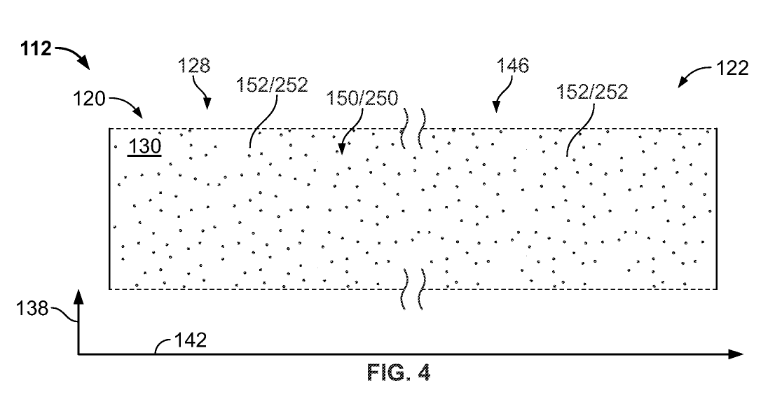

FIG. 3 is an expanded orthographic view of an exemplary portion of wind turbine blade 112 shown in FIG. 2 taken along area 3. A portion of skin 128, including outer surface 130, inner surface 132, thickness 134, and cavity 136 at root portion 120 are illustrated for perspective. Moreover, axes 138, 140 and 142 are illustrated for reference. FIG. 4 is an overhead view of the exemplary portion of wind turbine blade 112. Specifically, FIG. 4 illustrates a portion of blade 112 extending from root portion 120 to tip portion 122 from a perspective of looking down on outer surface 130. X-axis 138 and Z-axis 142 are illustrated for reference.

In an exemplary embodiment, skin 128 is at least partially formed of a fiber-resin matrix 150, wherein fiber-resin matrix 150 includes an innermost ply 144, an outermost ply 146, and an intermediate set of plies 148. Plies 148 extend between plies 144 and 146. Alternatively, skin 128 includes any number of plies that facilitates operation of blade 112 as described herein. Innermost ply 144 includes inner surface 132 and at least partially forms cavity 136. Outermost ply 146 includes outer surface 130.

Typically, using known hand lay-up fabrication methods to form a fiber-resin matrix, a layer of predetermined reinforcing material (not shown) is placed into a mold structure (not shown) and a predetermined resin (not shown) is subsequently added into the mold to saturate the reinforcing material, thereby at least partially forming a first layer of fiber-resin matrix 150. Additional layers may be added in a manner similar to that described above. Subsequently, the saturated layers are cured within the mold, wherein each of the layers form each of plies 144, 146, and 148 within fiber-resin matrix 150.

In an exemplary embodiment, hand lay-up methods of fiber-resin matrix fabrication similar to that described above are used. Alternatively, any known fabrication methods such as, but not limited to, known infusion methods, may be used.

In an exemplary embodiment, the reinforcing material is a plurality of layers of fiberglass and the resin is a thermosetting epoxy resin. Alternatively, any materials that facilitate forming blades 112 as described herein are used to form skin 128 including, but not limited to, carbon fiber, aramid fibers (such as Kevlar®, a registered trademark of E.I. DuPont de Nemours brand of fiber), vinylester, polymeric fibers, and polyester resins within predetermined structural strength, durability and compatibility parameters.

An exemplary method of forming wind turbine blade 112 includes at least partially forming a fiber-reinforced resin body by forming fiber-resin matrix 150. Fiber-resin matrix 150 is formed by producing at least one resin/additive mixture by mixing at least one opaque additive within a quantity of resin (neither shown).

In the exemplary embodiment, first ply 144 is partially formed by placing a first layer of fiberglass (not shown) in the mold and applying a portion of a first source of resin to the first layer such that the fiberglass is saturated with the resin. A second layer of fiberglass (not shown) is placed on top of the first layer and a portion of the first source of resin is applied to the second layer in a manner substantially similar to the first layer, thereby at least partially forming intermediate plies 148. Therefore, in an exemplary embodiment, fiber-resin matrix 150 is partially formed by applying a portion of the first source of resin to all layers of fiberglass as described above with the exception of the outermost layer that is used to form outermost ply 146.

At least one additive is mixed within a second source of resin, thereby forming a resin/additive mixture, prior to at least a portion of the resin/additive mixture being applied to the outermost fiberglass layer. In the exemplary embodiment, an opaque additive, such as a pigment 152 that includes titanium dioxide (TiO₂) and/or calcium carbonate (CaCO₃), is added to the second resin source to produce the resin/additive mixture. In an alternative embodiment, an additive that is any pigment and/or includes any pigmented substance that is mixed within the resin that facilitates forming blade 112 as described herein is used. Specifically, such exemplary and alternative additives alter the material characteristics and performance of the resin by causing it to be opaque and/or by adding color. In the exemplary embodiment, the volume percentage of pigment 152 with respect to the total resin/additive mixture volume, herein referred to as the pigment-to-resin/additive mixture volume percent, is typically less than one percent. More specifically, an exemplary range of values for the pigment-to-resin/additive mixture volume percent is approximately 0.10% to approximately 0.99% of the resin/additive mixture. Alternatively, any concentration of pigment 152 within the resin/additive mixture is used to provide any pigment-to-resin/additive mixture volume percent that facilitates forming skin 128 as described herein.

In the exemplary embodiment, pigment 152 is added to the second resin source such that the exemplary resin/additive mixture produced includes a substantially homogeneous distribution of pigment 152 throughout the resin/additive mixture. Specifically, in the exemplary embodiment, the distribution of pigment 152 between any two portions of blade 112 does not vary outside of a range of 0.1% to 5% throughout blade 112. The exemplary resin/additive mixture is applied to the outermost fiberglass layer such that a concentration of pigment 152 is substantially homogeneously distributed throughout the outermost layer from root portion 120 to tip portion 122. Such distribution facilitates subsequent formation of a substantially consistent opacity throughout the affected portions of skin 128. The fiberglass and resin within the mold are subsequently cured to form at least a portion of skin 128, or, more specifically, fiber-resin matrix 150 with plies 144, 146 and 148 fully formed.

In some embodiments, additional materials that include, but are not limited to, layer-separating materials (not shown) are used to form fiber-resin matrix 150. In the exemplary embodiment, outermost ply 146 is formed with an opacity that is within an opacity range that includes 95% and 100%. The 95% opacity value is qualitatively associated with visually observing outlines of some objects under outermost ply 146. The 100% opacity value is qualitatively associated with not being able to observe any portions of blade 112 under ply 146. Alternatively, outermost ply 146 has any opacity that facilitates operation of blade 112 as described herein.

Forming blades 112 with such additives as described herein decreases a variety of capital costs associated with blade 112 fabrication including, but not limited to, painting and/or gel coating labor and materials. Moreover, forming blade 112 as described herein facilitates reducing fabrication times as well as mitigating a need for large, dedicated painting and coating spaces within a fabrication facility. Removal stages of blade 112 fabrication that include gel coating facilitates a reduction in fabrication cycle times, a reduction in a number of molds and other tooling that would be otherwise engaged elsewhere during the gel coating process, and/or an increase in fabrication throughput with a given number of molds.

Also, eliminating paint and other coatings facilitates reducing the weight of blade 112 by approximately 100 to 200 kilograms (kg) (220 to 440 pounds (lbs)) for a blade 112 with a surface area of approximately 150 square meters (m²) (1615 square feet (ft²)). Furthermore, an alternative embodiment may include forming an integral external abrasion layer (not shown) that facilitates increasing abrasion tolerance. Moreover, if subsequent paint and/or gel coat layers are desired to be formed on blades 112 that have been placed in service, previous layers do not need to be removed, thereby facilitating a reduction in maintenance costs and an increase in wind turbine 100 power generation availability.

In one alternative embodiment, a plurality of resin/additive mixtures are formed, wherein each of such plurality of resin/additive mixtures includes a corresponding unique concentration of pigment 152. Specifically, at least, a first resin/additive mixture is produced with a first pigment concentration and a second resin/additive mixture is produced with a second pigment concentration, wherein the second pigment concentration is less than the first pigment concentration. Therefore, a first opacity associated with the first pigment concentration is greater than a second opacity associated with the second pigment concentration. Subsequently, the second resin/additive mixture is applied to a portion of blade 112, for example, root portion 120 and the first resin/additive mixture is applied to another portion of blade 112, for example, tip portion 122. This method reduces the opacity of portions of blade 112 with greater wall thicknesses 134, specifically, root portion 120. The reduced opacity facilitates performance of non-destructive examinations (NDE), or, specifically, visual examinations, of root portion 120, thereby facilitating enhanced detection of deformations within skin 128 at root portion 120.

In a second alternative embodiment, the resin/additive mixture is applied to a plurality of fiberglass layers. Such embodiments include using hand lay-up methods as described above to apply the resin/additive mixture to the desired layers within blade 112. At least some criteria for selecting which of plies 144, 146 and 148 receive the resin/additive mixture include avoidance of prefabricated fiberglass components that are not scheduled to receive pigment 152, fabrication resource allocations, fabrication time constraints and unique component specifications. A third alternative embodiment includes using known infusion methods that include, but are not limited to, vacuum-assisted resin injection to facilitate application of the resin/additive mixture substantially homogeneously throughout all of plies 144, 146 and 148.

In the exemplary embodiment, pigment 152 includes a predetermined shade of white and/or gray and/or red (wherein red may be used to facilitate meeting aviation safety standards). Alternatively, pigment 152 includes any color that facilitates forming blade 112 as described herein, including, but not limited to, shades of brown and/or blue and/or green that facilitate aesthetically integrating wind turbine 100 (shown in FIG. 1) within a surrounding environment (not shown).

In other alternative embodiments, a variety of alternative additives are mixed within the resin to form alternative opaque and/or colored resin/additive mixtures. Examples of such alternative opaque and/or colored additives include, but are not limited to, water-resistant additives, abrasion-resistant additives, and ultraviolet-resistant additives. In these alternative embodiments, any concentration of such additives within the alternative resin/additive mixtures is used that facilitates forming skin 128 as described herein. Additional further alternative embodiments include formation of at least one layer of paint and/or gel coat over a portion of surface 130.

In further alternative embodiments, pigment-to-resin/additive mixture volume percent values, or pigment concentrations, are varied as a function of position between root portion 120 and tip portion 122 along z-axis 142. Moreover, alternatively, pigment concentrations are varied as a function of position between leading edge 124 and trailing edge 126 (both shown in FIG. 2) along x-axis 138. Furthermore, alternatively, pigment concentrations are varied as a function of position between inner surface 132 and outer surface 130 along y-axis 140, either as discrete, substantially homogenous values within each of plies 144, 146 and 148 or as a continuum across plies 144, 146 and 148. Also, alternatively, any combination of such alternative pigment concentration variations may be used.

Moreover, other alternative embodiments include varying additives and/or pigments and/or pigment concentrations within a variety of prefabricated portions, or components, of blade 112 and subsequently assembling blade 112. Furthermore, other alternative embodiments include methods of resin infusion wherein one portion of blade 112 is infused with a first resin/additive mixture and another portion of blade 112 is infused with a second resin/additive mixture. For example, but not being limited to, blade tip portion 122 is infused with a white resin/additive mixture and blade root portion 120 is infused with a differently colored resin/additive mixture (or, just resin) wherein a transition region between portions 120 and 122 is formed.

An alternative method of forming wind turbine blade 112 includes at least partially forming an alternative fiber-reinforced resin body by forming an alternative fiber-resin matrix 250. Forming alternative fiber-resin matrix 250 includes forming a layer of fibers having a plurality of pigmented fibers 252. Forming plurality of pigmented fibers 252 includes at least one of impregnating at least a portion of the layer of fibers with at least one opaque additive (not shown) and forming at least one layer of opaque coating (not shown) over at least a portion of the layer of fibers. FIGS. 3 and 4 illustrate at least a portion of some of these alternative embodiments.

Such alternative embodiments include impregnating at least a portion of the reinforcing fibers of fiber-resin matrix 250 with an opaque additive prior to the addition of the resin (neither shown). Some further additional embodiments include applying at least one layer of an opaque coating (not shown) to at least a portion of the reinforcing fibers (not shown) of fiber-resin matrix 250 with an opaque additive prior to the addition of the resin. The opaque additive material and opaque coating material may or may not be similar to pigment 152. The opaque additive-impregnated and/or -coated fibers, that is pigmented fibers, are used in the outermost fiberglass layer to facilitate forming blade 112 as described herein. Specifically, such alternative opaque pigmented fibers alter the material characteristics and performance of the fibers by causing them to be opaque and/or by adding color. Moreover, in these alternative embodiments, the weight attributes as described above associated with resin matrix 150 and the concentration of pigment 152 are similar with respect to the opaque additive and/or opaque coating within fiber-resin matrix 250 and pigmented fibers 252.

Also, in these alternative embodiments, the distribution of the pigmented fibers within the outermost layer of fiber-resin matrix 250 from root portion 120 to tip portion 122 may be substantially homogeneous. Therefore, in the these alternative embodiments, outermost ply 146 may be formed with an opacity that is within an opacity range that includes 95% and 100%. In further alternative embodiments, pigmented fiber concentrations may be varied as a function of position between root portion 120 and tip portion 122 along z-axis 142. Moreover, alternatively, pigmented fiber concentrations may be varied as a function of position between leading edge 124 and trailing edge 126 (both shown in FIG. 2) along x-axis 138. Furthermore, alternatively, pigmented fiber concentrations may be varied as a function of position between inner surface 132 and outer surface 130 along y-axis 140, either as discrete, substantially homogenous values within each of plies 144, 146 and 148 or as a continuum across plies 144, 146 and 148. Also, alternatively, any combination of such alternative pigmented fiber concentration variations may be used. Moreover, other alternative embodiments include varying pigmented fiber concentrations within a variety of prefabricated portions, or components, of blade 112 and subsequently assembling blade 112.

The methods for forming wind turbine blades as described herein facilitates assembly of a wind turbine system. More specifically, the method of forming the wind turbine blade as described above facilitates decreasing assembly time, labor and capital costs associated with applying external blade coatings.

Exemplary embodiments of wind turbine blades as associated with wind turbine systems are described above in detail. The methods, apparatus and systems are not limited to the specific embodiments described herein nor to the specific illustrated wind turbine blades.

While the invention has been described in terms of various specific embodiments, those skilled in the art will recognize that the invention can be practiced with modification within the spirit and scope of the claims.

What is claimed is:

1. A method of forming a wind turbine blade, said method comprising:
forming a fiber-reinforced resin body including a fiber-resin matrix formed with, at least partially, at least one of:
at least one resin/additive mixture produced by mixing at least one first opaque additive within a first quantity of resin; and
a first layer of fibers having a plurality of pigmented fibers formed by at least one of:
impregnating at least a portion of the first layer of fibers with at least one second opaque additive; and
forming at least one layer of opaque coating over at least a portion of the first layer of fibers, the opaque coating having a third opaque additive.

2. A method in accordance with claim 1 further comprising one of:
applying the at least one resin/additive mixture to at least a portion of a second layer of fibers; and
applying a second quantity of resin to the first layer of fibers.

3. A method in accordance with claim 2 wherein applying the at least one resin/additive mixture to at least a portion of the second layer comprises applying each of a plurality of resin/additive mixtures to respectively different portions of the second layer.

4. A method in accordance with claim 3 wherein producing at least one resin/additive mixture further comprises producing the plurality of resin/additive mixtures by mixing varying proportions of the at least one additive within each of a plurality of quantities of resin.

5. A method in accordance with claim 1 wherein forming a fiber-reinforced resin body comprises:
forming a first portion of the wind turbine blade to have a first opacity; and
forming a second portion of the wind turbine blade to have a second opacity that is less than the first opacity.

6. A method in accordance with claim 5 wherein forming a first portion of the wind turbine blade with a first opacity comprises forming the first portion of the turbine blade with an opacity range of 95% to 100%.

7. A method in accordance with claim 5 wherein forming a first portion of the wind turbine blade with a first opacity comprises tinting at least a portion of the wind turbine blade with at least one predetermined color.

8. A method in accordance with claim 1 wherein forming a fiber-reinforced resin body including a fiber-resin matrix formed with, at least partially, at least one resin/additive mixture produced by mixing at least one first opaque additive within a first quantity of resin comprises producing at least one resin/additive mixture by mixing the least one first opaque additive within the first quantity of resin such that the at least one first opaque additive comprises less than one volume percent of the total resin volume in the wind turbine blade.

9. A wind turbine blade comprising a fiber-reinforced resin body at least partially formed from one of:
at least one resin/additive mixture, said at least one resin/additive mixture comprises at least one first opaque additive mixed within a quantity of resin; and
a first layer of fibers having a plurality of pigmented fibers, said pigmented fibers comprising at least one of:
at least a portion of the first layer of fibers impregnated with at least one second opaque additive; and
at least one layer of opaque coating over at least a portion of the first layer of fibers, wherein said opaque coating comprises at least one third opaque additive.

10. A wind turbine blade in accordance with claim 9 wherein each of said at least one first, second and third additives comprise at least one pigment.

11. A wind turbine blade in accordance claim 10 wherein said at least one pigment comprises less than one volume percent of said wind turbine blade.

12. A wind turbine blade in accordance with claim 10 wherein said at least one pigment comprises at least one of:
titanium dioxide (TiO₂); and
calcium carbonate (CaCO₃).

13. A wind turbine blade in accordance with 9 wherein said at least one first opaque additive comprises at least one of:
a water-resistant additive;
an abrasion-resistant additive; and
an ultraviolet-resistant additive.

14. A wind turbine blade in accordance with claim 9 wherein at least a portion of said fiber-reinforced resin body comprises at least one of:
an opacity that is with an opacity range of 95% to 100%; and
at least one predetermined color.

15. A wind turbine system comprising:
a rotatable hub; and
at least one wind turbine blade coupled to said rotatable hub, said at least one wind turbine blade comprises a fiber-reinforced resin body at least partially formed from one of:
at least one resin/additive mixture, said at least one resin/additive mixture comprises at least one first opaque additive mixed within a quantity of resin; and
a first layer of fibers having a plurality of pigmented fibers, said pigmented fibers comprising at least one of:
at least a portion of the first layer of fibers impregnated with at least one second opaque additive; and
at least one layer of opaque coating over at least a portion of the first layer of fibers, wherein said opaque coating comprises at least one third opaque additive.

16. A wind turbine system in accordance with claim 15 wherein each of said at least one first, second and third additives comprise at least one pigment.

17. A wind turbine system in accordance with claim 16 wherein said at least one pigment comprises less than one volume percent of said wind turbine blade.

18. A wind turbine system in accordance with claim 16 wherein said at least one pigment comprises at least one of:
titanium dioxide (TiO₂); and
calcium carbonate (CaCO3).

19. A wind turbine system in accordance with claim 15 wherein said at least one first opaque additive comprises at least one of:
a water-resistant additive;
an abrasion-resistant additive; and
an ultraviolet-resistant additive.

20. A wind turbine system in accordance with claim 15 wherein at least a portion of said fiber-reinforced resin body comprises at least one of:
an opacity that is with an opacity range of 95% to 100%; and
at least one predetermined color.
